(19) United States
(12) Patent Application Publication
(10) Pub. No.: US 2021/0404477 A1
(43) Pub. Date: Dec. 30, 2021

(54) AIRFLOW-GENERATING DEVICE WITH ABILITY TO ADJUST AIR CHAMBER AND METHOD APPLIED THERETO

(71) Applicant: POWER LOGIC TECH. INC., New Taipei City (TW)

(72) Inventors: Wen-Faung HSU, New Taipei City (TW); Chia-Heng HSU, New Taipei City (TW); Chung-Lin HSIEH, New Taipei City (TW)

(21) Appl. No.: 16/912,016

(22) Filed: Jun. 25, 2020

(51) Int. Cl. F04D 27/00; F04D 29/66

(52) U.S. Cl. CPC F04D 27/002; F04D 29/663

(57) ABSTRACT

An airflow-generating device which can adjust an air chamber volume and a method applied thereto are provided. The device has a volume-adjustable air chamber and an airflow-generating unit. The volume-adjustable air chamber has an inlet structure, an outlet structure, and an adjustment unit. A deflector structure for adjusting pressure or direction of airflow is arranged in the outlet structure, and an air chamber space is formed between the inlet structure and the outlet structure. The adjustment unit is used to adjust an inlet-outlet distance between the inlet structure and the outlet structure for adjusting the volume of the air chamber. The airflow-generating unit is arranged in the volume-adjustable air chamber and used to generate the airflow introduced from the inlet structure into the air chamber space and exhausted from the outlet structure. The present disclosed example can increase the intensity or reduce the noise of the airflow.

### BACKGROUND OF THE INVENTION

### Field of the Invention

The technical field relates to an airflow-generating device and a method thereof, and more particularly related to an airflow-generating device with ability to adjust an air chamber volume and a method applied thereto.

### Description of Related Art

Existing airflow-generating devices cannot adjust their air chamber volumes. Thus, when an airflow-generating device generates high-speed airflow in a high power operation, an obvious noise will be generated by the high-speed airflow, as the air chamber volume may be too small; on the other hand, when the airflow-generating device generates low-speed airflow in a low power operation, the air exchange rate will become substantially poor, as the air chamber volume may now be too large.

Thus, as existing airflow-generating devices have the above-mentioned problems, there is a need for a more effective solution.

### SUMMARY OF THE INVENTION

The present disclosed example is direct to an airflow-generating device with ability to adjust an air chamber volume and a method applied thereto based on demands for adapting the different intensities of the airflow.

In one of the exemplary embodiments, an airflow-generating device comprises a volume-adjustable air chamber and an airflow-generating unit. The volume-adjustable air chamber comprises an inlet structure, an outlet structure, and an adjustment unit. An air chamber space is formed between the inlet structure and the outlet structure, and a deflector structure for adjusting pressure or direction of airflow is arranged on the outlet structure. The adjustment unit is used to adjust an inlet-outlet distance between the inlet structure and the outlet structure for adjusting an air chamber volume of the adjustable air chamber. The airflow-generating unit is arranged in the volume-adjustable air chamber and used to generate the airflow introduced from the inlet structure into the air chamber space and exhausted from the outlet structure.

In one of the exemplary embodiments, a method applied to the above airflow-generating device, comprises following steps of detecting a rotation rate of the airflow-generating unit; retrieving a movement distance corresponding to the rotation rate currently changed of the airflow-generating unit when the rotation rate of the airflow-generating unit is changed; and controlling the adjustment unit to stretch or shrink the inlet-outlet distance based on the movement distance, wherein the inlet-outlet distance is stretched when the rotation rate of the airflow-generating unit speeds up for increasing the air chamber volume to improve a noise level caused by the airflow, and the inlet-outlet distance is shrunk when the rotation rate of the airflow-generating unit slows down for reducing the air chamber volume to aggrandize the pressure and speed of the airflow.

The present disclosed example can increase the intensity of the airflow or reduce the noise of the airflow according to the user demand.

### BRIEF DESCRIPTION OF DRAWINGS

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is the schematic view of operation of the existing airflow-generating device;

FIG. 2A is the first schematic view of operation of the airflow-generating device of the first implement aspect of the present disclosed example;

FIG. 2B is the second schematic view of operation of the airflow-generating device of the first implement aspect of the present disclosed example;

FIG. 2C is the third schematic view of operation of the airflow-generating device of the first implement aspect of the present disclosed example;

FIG. 3A is the first schematic view of operation of the airflow-generating device of the second implement aspect of the present disclosed example;

FIG. 3B is the second schematic view of operation of the airflow-generating device of the second implement aspect of the present disclosed example;

FIG. 3C is the third schematic view of operation of the airflow-generating device of the second implement aspect of the present disclosed example;

FIG. 4 is the architecture diagram of the airflow-generating device of the third implement aspect of the present disclosed example;

FIG. 5 is the architecture diagram of the control unit of the fourth implement aspect of the present disclosed example;

FIG. 6 is the schematic view of the volume-adjustable air chamber of the fifth implement aspect of the present disclosed example;

FIG. 7 is the schematic view of the volume-adjustable air chamber of the sixth implement aspect of the present disclosed example;

FIG. 8 is the schematic view of the volume-adjustable air chamber of the seventh implement aspect of the present disclosed example;

FIG. 9 is the schematic view of the volume-adjustable air chamber of the eighth implement aspect of the present disclosed example;

FIG. 10 is the flowchart of the method of adjusting volume of air chamber of the first embodiment of the present disclosed example;

FIG. 11 is the flowchart of moving based on condition of the second embodiment of the present disclosed example; and

FIG. 12 is the flowchart of the anomaly detection of the third embodiment of the present disclosed example.

### DETAILED DESCRIPTION OF THE INVENTION

In cooperation with attached drawings, the technical contents and detailed description of the present disclosed example are described thereinafter according to a preferred embodiment, not being used to limit its executing scope. Any equivalent variation and modification made according to appended claims is all covered by the claims claimed by the present disclosed example.

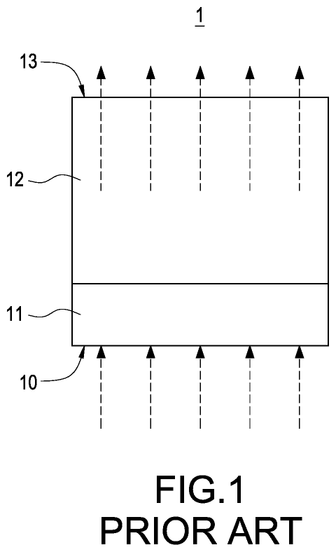

Please refer to FIG. 1. FIG. 1 is the schematic view of operation of the existing airflow-generating device. FIG. 1 is used to clearly explain the problems mainly solved by the present disclosed example.

As shown in the figure, the existing airflow-generating device 1 generates airflow by operating the fan 11, so as to inhale air from the inlet 10 into the air chamber 12 and discharge air from the outlet 13. Moreover, the intensities of airflow and noise can be determined by the volume of the air chamber 12.

More specifically, because the volume of the air chamber 12 is fixed and unchangeable, the intensity of noise (such as wind noise) generated at the outlet 13 will significantly increase when the fan 11 enhances its operational power to intensify the airflow (instantaneous displacement) over the load of the air chamber 12; the wind speed and pressure at the outlet 13 significantly lowers and the air exchange rate becomes substantially poor when the fan 11 reduces its operational power to lower the intensity of the airflow far below the load of air chamber 12.

To solve the above-mentioned problem, an airflow-generating device with ability to adjust air chamber volume (hereinafter the airflow-generating device for abbreviation) and a method applied thereto are provided by the present disclosed example.

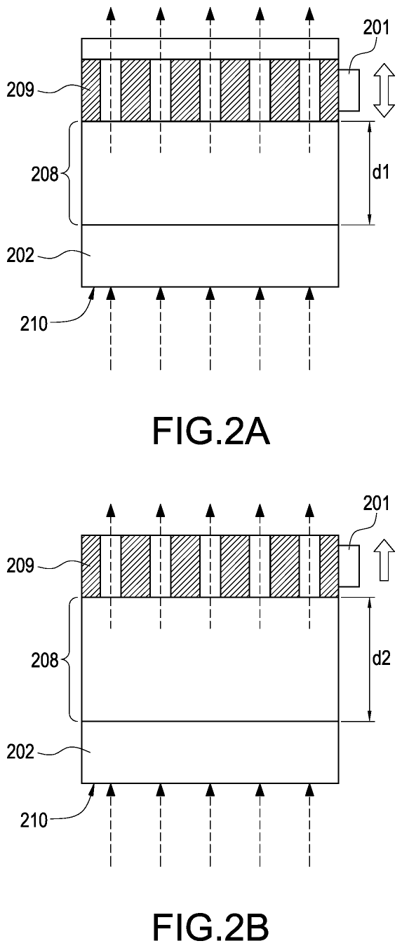

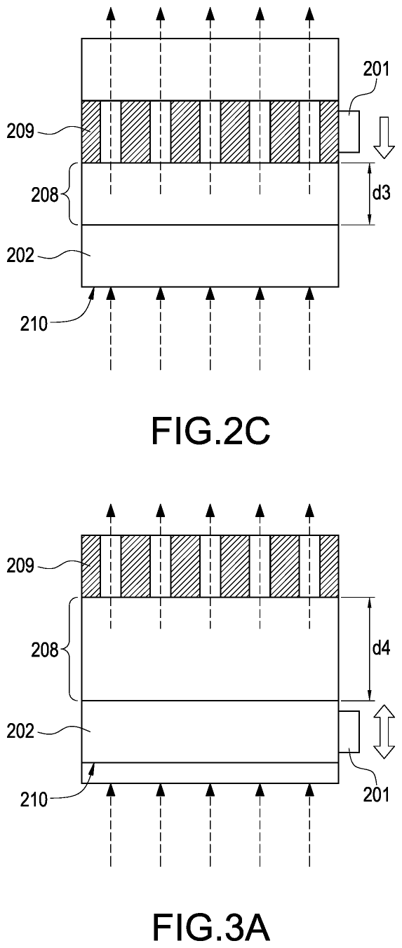

Please refer to FIG. 2A to FIG. 2C together. FIG. 2A is the first schematic view of operation of the airflow-generating device of the first implement aspect of the present disclosed example, FIG. 2B is the second schematic view of operation of the airflow-generating device of the first implement aspect of the present disclosed example, and FIG. 2C is the third schematic view of operation of the airflow-generating device of the first implement aspect of the present disclosed example.

In this implement aspect, as shown in FIG. 2A, the airflow-generating device mainly comprises a volume-adjustable air chamber and an airflow-generating unit 202 (such as fan device).

The volume-adjustable air chamber may comprise an inlet structure 210, an outlet structure 209, an air chamber space 208 and an adjustment unit 201. The air chamber space 208 is formed by the inlet structure 210 and the outlet structure 209. The adjustment unit 201 is used to adjust an inlet-outlet distance between the inlet structure 210 and the outlet structure 209 (such as the inlet-outlet distance d1 shown in FIG. 2A) for adjusting the volume of the air chamber space 208.

In this implement aspect, the inlet structure 210 is fixedly arranged (namely, the installation position of the inlet structure 210 is unmovable). The adjustment unit 201 is physically connected to the outlet structure 209, and has the ability to move the outlet structure 209 to approach to the inlet structure 210 or keep away from the inlet structure 210 for adjusting the inlet-outlet distance.

The airflow-generating unit 202 is exemplarily installed in the volume-adjustable air chamber and used to generate the airflow introduced from the inlet structure 210 into the air chamber space 208 and exhausted from the outlet structure 209.

In one of the implement aspects, at least one deflector structure (such as a plurality of deflector holes shown in FIG. 2A) are on the outlet structure 209, and the above deflector structure can adjust the pressure (such as adjusting the aperture of each deflector hole) or the direction (such as adjusting the orientation in which each hole faces) of the above-mentioned airflow.

As shown in FIG. 2B, when the user needs to increase the volume of the air chamber space 208, such as when the noise caused by the strong airflow generated by the high rotation rate of the airflow-generating unit 202 is too loud, the operation may be executed (such manual operation by the user or automatic adjustment by the airflow-generating device) to control the adjustment unit 201 to move the outlet structure 209 in a direction keeping away from the inlet structure 210, so as to increase the inlet-outlet distance as d2, the volume of the air chamber space 208 is increased, weakening the noise caused by the airflow.

As shown in FIG. 2C, when the user needs to reduce the volume of the air chamber space 208, such as when there is a poor air exchange rate caused by the weak airflow generated by the low rotation rate of the airflow-generating unit 202, the operation may be executed (such manual operation by the user or automatic adjustment by the airflow-generating device) to control the adjustment unit 201 to make the outlet structure 209 to move in a direction of approaching to the inlet structure 210, so as to reduce the inlet-outlet distance as d3, the volume of the air chamber space 208 is reduced, the wind speed and the pressure is increased, improving the air exchange rate.

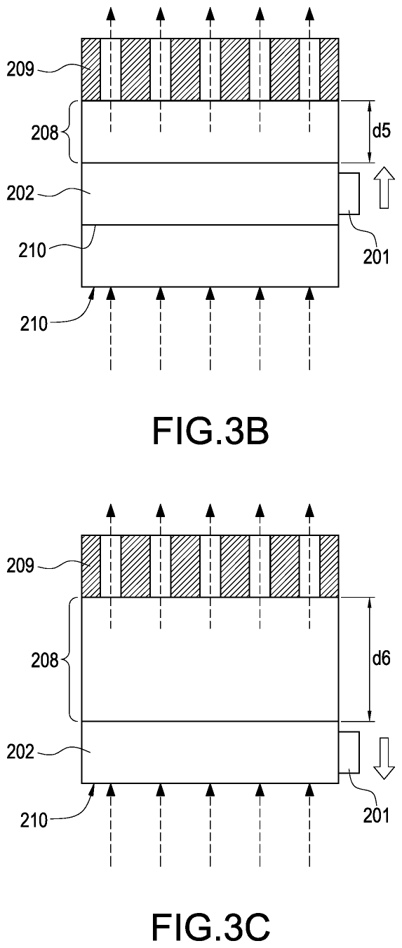

Please refer to FIG. 3A to 3C together. FIG. 3A is the first schematic view of operation of the airflow-generating device of the second implement aspect of the present disclosed example, FIG. 3B is the second schematic view of operation of the airflow-generating device of the second implement aspect of the present disclosed example, and FIG. 3C is the third schematic view of operation of the airflow-generating device of the second implement aspect of the present disclosed example.

In comparison with the first implement aspect shown in FIGS. 2A to 2C, in this implement aspect, the outlet structure 209 is fixedly arranged (namely, the installation position of the outlet structure 209 is unmovable). The adjustment unit 201 is physically connected to the inlet structure 210, and has the ability to move the inlet structure 210 (the airflow-generating unit 202 may be moved together) towards the outlet structure 209 or away from the outlet structure 209 for adjusting the inlet-outlet distance. In FIG. 3A, the inlet-outlet distance is expressed by d4.

As shown in FIG. 3B, when the user needs to reduce the volume of air chamber space 208, the operation may be executed (such manual operation by the user or automatic adjustment by the airflow-generating device) to control the adjustment unit 201 to move the inlet structure 210 in a direction of approaching to the outlet structure 209 (in an example, only the airflow-generating unit 202 is moved), so as to reduce the inlet-outlet distance as d5, the volume of the air chamber space 208 is reduced, the wind speed and the pressure is increased, improving the air exchange rate.

As shown in FIG. 3B, when the user needs to increase the volume of air chamber space 208, the operation may be executed (such manual operation by the user or automatic adjustment by the airflow-generating device) to control the adjustment unit 201 to move the inlet structure 210 in a direction away from the outlet structure 209, so as to increase the inlet-outlet distance as d6, the volume of the air chamber space 208 is increased, weakening the noise caused by the airflow.

Please note that although the above implement aspects take it for example that the adjustment unit 201 is connected to either the inlet structure 210 or the outlet structure 209, this specific example is not intended to limit the scope of the present disclosed example.

In one of the implement aspects, the adjustment unit 201 may be configured to be physically connected to the inlet structure 210 and the outlet structure 209 simultaneously, and drive the inlet structure 210 and the outlet structure 209 to move simultaneously for adjustment of the inlet-outlet distance.

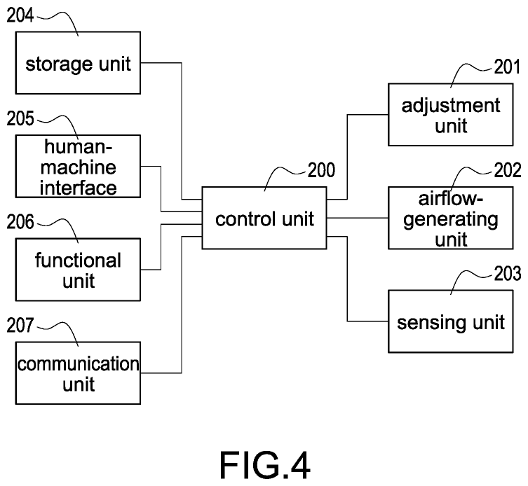

Please refer to FIG. 4. FIG. 4 is the architecture diagram of the airflow-generating device of the third implement aspect of the present disclosed example. FIG. 4 further shows the electronic module architecture of the airflow-generating device.

More specifically, in addition to comprising the adjustment unit 201 and the airflow-generating unit 202, the airflow-generating device may further comprise a sensing unit 203, a storage unit 204, a human-machine interface 205, a communication unit 207 and a control unit 200 electrically connected to the above components.

The sensing unit 203 is used to sense the environmental parameters. In one of the implement aspects, the sensing unit 203 is an anemometer, installed on the outlet structure 209, and used to sense the wind speed reading value of the airflow flowing through the outlet structure 209. In one of the implement aspects, the sensing unit 203 is a barometer, installed on the outlet structure 209, and used to sense the air pressure value of the airflow flowing through the outlet structure 209. In one of the implement aspects, the sensing unit 203 is a decibel meter, installed on the outlet structure 209, and used to sense the noise reading value of the airflow flowing through the outlet structure 209.

The storage unit 204 is used to store data. The human-machine interface 205, such as a display, indicator, button, touch screen, or any combination of the above interfaces, is used to interact with the user. The communication unit 207, such as an NFC module, Bluetooth module, Wi-Fi module, cellular network module, Zigbee module, Ethernet module, infrared transceiver or any combination of the above communication devices, is used to communicate with the external device.

In one of the implement aspects, the communication unit 207 may be connected to the network and connected to the user device and/or cloud server by the network to receiving commands or update based on the user device and/or cloud server, so as to implement the remote control or automatically update.

In one of the implement aspects, the user may operate the user device, such as the remote controller or the networking mobile device installed the designated application program, to generate and send the operational command to the communication unit 207. The control unit 200 may control the airflow-generating device based on the received operational command, such as turning on/off the airflow-generating unit 202, adjusting the operational parameters of the airflow-generating unit 202, reporting the operational parameters, and so forth.

In one of the implement aspects, the airflow-generating device may comprise a case, and the case may partially or completely cover the airflow-generating device for providing the protection.

The control unit 200 is used to control the operation of each component of the airflow-generating device.

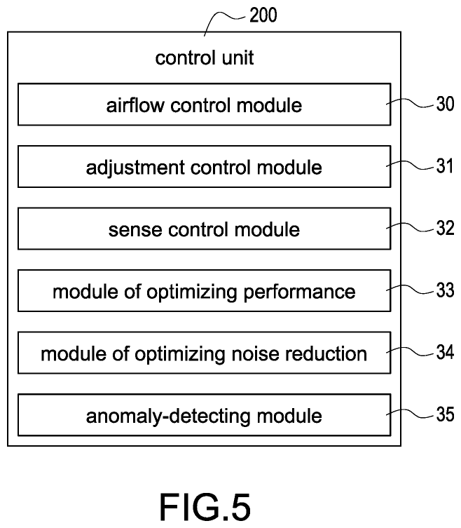

Please refer to FIG. 5. FIG. 5 is the architecture diagram of the control unit of the fourth implement aspect of the present disclosed example. In the present disclosed example, the control unit 200 of the airflow-generating device may comprise the following modules for implementing the different functions.

1. The Airflow control module 30, is configured to adjust the operational parameters (such as the rotation rate or the electronic power) of the airflow-generating unit 202 for controlling the operational status of the airflow-generating unit 202.

2. The adjustment control module 31, is configured to control the adjustment unit 201 for adjustment of the inlet-outlet distance between the inlet structure 210 and the outlet structure 209.

In one of the exemplary embodiments, the adjustment control module 31 may be configured to automatically control the adjustment unit 201 to stretch the inlet-outlet distance when the rotation rate of the airflow-generating unit 202 speeds up for increasing the volume of the air chamber space 208 and reducing the noise caused by the airflow. The adjustment control module 31 may further be configured to automatically control the adjustment unit 201 to shrink the inlet-outlet distance when the rotation rate of the airflow-generating unit 202 slows down for reducing the volume of the air chamber space 208 and aggrandizing the pressure and speed of the airflow.

3. The sense control module 32, is configured to retrieve the sensed reading values from the sensing unit 203.

4. The module of optimizing performance 33, is configured to be triggered under a mode of optimizing performance, and the module of optimizing performance 33 is configured to retrieve the sense reading values related to the performance (such as the wind speed reading values or the air pressure reading values) continuously from the sensing unit 203, controlling the adjustment unit 201 to increase or reduce the above-mentioned inlet-outlet distance until a threshold condition is matched, such as the current wind reading value being matched with a threshold condition for wind speed (such as a default wind speed reading), or the current air pressure reading value being matched with a threshold condition for air pressure (such as a default air pressure reading. Thus, the present disclosed example can ensure that the airflow-generating device provides the performance matched with the user's expectation.

5. The module of optimizing noise reduction 34, is configured to be triggered under a mode of optimizing noise reduction, and the module of optimizing noise reduction 34 is configured to retrieve the noise reading values from the sensing unit 203 continuously, controlling the adjustment unit 201 to increase or reduce the inlet-outlet distance until the noise reading value is matched with a threshold condition for noise (such as a designated decibel value). Thus, the present disclosed example can ensure that the noise generated by the airflow-generating device is acceptable by the user.

6. The anomaly-detecting module 35, is configured to detect whether there is any abnormal situation happening during the adjustment unit 201 adjusting the inlet-outlet distance, and controls the adjustment unit 201 to discontinue the adjustment of the inlet-outlet distance for preventing the adjustment unit 201 or the other components from damage caused by the anomaly when any abnormal situation is detected.

Please note that the above-mentioned modules 30-35 are connected to each other (such as by electrical connection or information link), and each module 30-35 could be a hardware module (such as electronic circuit module, integrated circuit module, SoC, etc.), a software module or a combination of the hardware module and the software module, this specific example is not intended to limit the scope of the present disclosed example.

Please note that if each of the above-mentioned modules 30-35 is a software module, such as firmware, operating systems or application programs, the storage unit 204 may comprise a non-transitory computer-readable media. The non-transitory computer-readable media stores a computer program. The computer program records a plurality of computer-readable codes. When the control unit 200 executes the above computer-readable codes, the control functions of the corresponding above-mentioned modules 30-35 can be achieved.

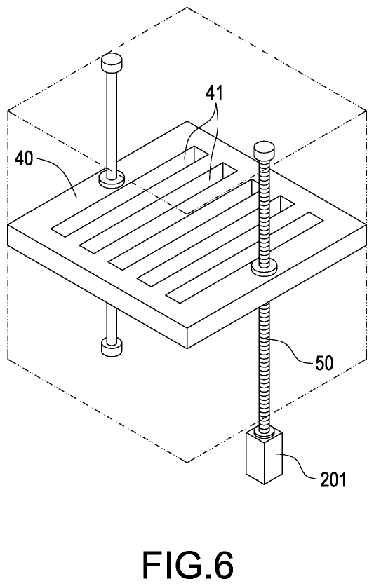

Please refer to FIG. 3A to FIG. 3C and FIG. 6 together. FIG. 6 is the schematic view of the volume-adjustable air chamber of the fifth implement aspect of the present disclosed example. In this implement aspect, the adjustment unit 201 is a screw structure device, the deflector structure 40 of the outlet structure 209 comprises a plurality of plane holes 41.

More specifically, at least one screw structure 50 is installed through the deflector structure 40 and is perpendicular to the deflector structure 40. In the example shown in FIG. 6, one screw structure 50 and one guide rod are installed through the deflector structure 40 and is perpendicular to the deflector structure 40 for reducing the number of the screw structure 50 necessary to be rotated and for maintaining the balance while moving. The adjustment unit 201 may comprise the motor and the other transmission parts, and can turn the screw structure 50 for lifting the deflector structure 40 (or the whole outlet structure 209). Namely, the adjustment unit 201 makes the deflector structure 40 approach or move away from the inlet structure 210.

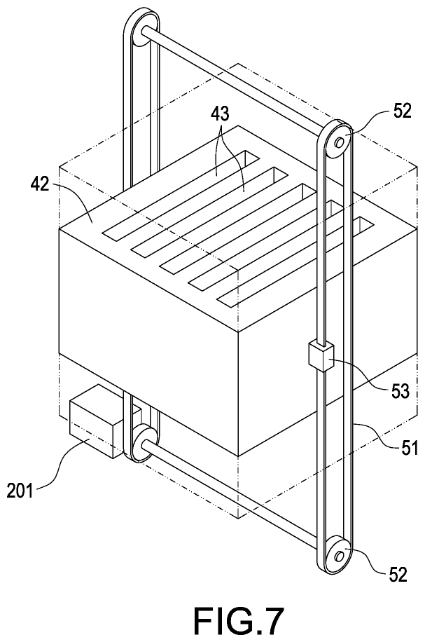

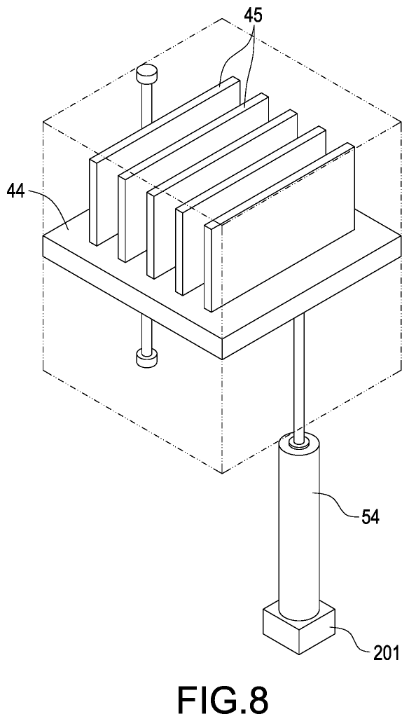

Please refer to FIG. 3A to FIG. 3C and FIG. 7 together. FIG. 7 is the schematic view of the volume-adjustable air chamber of the sixth implement aspect of the present disclosed example. In this implement aspect, the adjustment unit 201 is a belt driving device, and the deflector structure 42 of the outlet structure 209 comprises a plurality of stereo holes 43.

More specifically, the moving block 53 is fixedly installed on the deflector structure 42 and the drive belt 51. The adjustment unit 201 may comprise the motor or the other transmission parts, and may rotate the drive component 52 to drive the drive belt 51, so as to lift the moving block 53 and the deflector structure 42 (or the whole outlet structure 209). Namely, the adjustment unit 201 makes the deflector structure 42 approach or move away from the inlet structure 210.

Please refer to FIG. 3A to FIG. 3C and FIG. 8 together. FIG. 8 is the schematic view of the volume-adjustable air chamber of the seventh implement aspect of the present disclosed example. In this implement aspect, the adjustment unit 201 is a pneumatic telescopic rod device, and the deflector structure 44 of the outlet structure 209 comprises a plurality of stereo deflectors 45.

More specifically, at least one pneumatic telescopic rod 54 is installed through the deflector structure 44 and is perpendicular to the deflector structure 44. In the example shown in FIG. 8, one pneumatic telescopic rod 54 and one guide rod are installed through the deflector structure 44 and is perpendicular to the deflector structure 44 for reducing the number of the pneumatic telescopic rod 54 necessary to be stretched and for maintaining the balance while moving. The adjustment unit 201 may comprise the pneumatic parts, and can stretch or shrink the pneumatic telescopic rod 54 for lifting the deflector structure 44 (or the whole outlet structure 209). Namely, the adjustment unit 201 makes the deflector structures 44 approach or move away from the inlet structure 210.

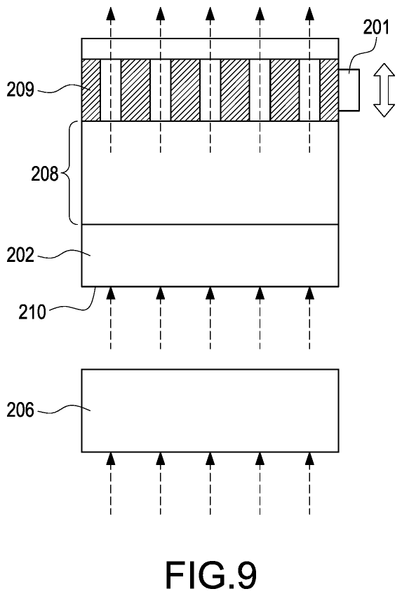

Please refer to FIG. 4 and FIG. 9 together. FIG. 9 is the schematic view of the volume-adjustable air chamber of the eighth implement aspect of the present disclosed example.

In this implement aspect, as shown in FIG. 4, the airflow-generating device further comprises a functional unit 206 electrically connected to the control unit 200. The functional unit 206 is used to implement a designated function, such as a purification function, heating function, cooling function, dehumidification function, vacuum cleaning function, etc.

As shown in FIG. 9, the functional unit 206 is arranged at a position which the airflow flows through before the inlet structure 210, the functional unit 206 is used to process the air before the inlet structure 210, the airflow-generating unit 202 introduces the air being processed in the air chamber space 208, and the air flows out from the outlet structure 209.

In one of the implement aspects, the functional unit 206 is an air purification device and may comprise a filter module. The effect of air purification can be achieved when the air is introduced by the airflow-generating unit 202 and goes through the filter module.

In one of the implement aspects, the functional unit 206 is an air heating device and comprises a heating module. The effect of warm room can be achieved when the air is introduced by the airflow-generating unit 202 and goes through the heating module.

In one of the implement aspects, the functional unit 206 is an air-cooling device and comprises a cooling module. The effect of cold room can be achieved when the air is introduced by the airflow-generating unit 202 and goes through the cooling module.

In one of the implement aspects, the functional unit 206 is an air dehumidification device and comprises a dehumidifying module for absorbing moisture in the ambient air for generating dry air, a heating module for evaporating the moisture absorbed by the dehumidifying module for making the dehumidifying module maintain the ability to absorb moisture, and a heat exchanging module for condensing and collecting the evaporated moisture (water vapor). The effect of dehumidification can be achieved when the air is introduced by the airflow-generating unit 202 and goes through the air dehumidification device.

In one of the exemplary embodiments, the functional unit 206 is a vacuum cleaner device and comprises a vacuum cleaning module for absorbing trash or dust on the floor, and a dust collection module for collecting the trash or dust being absorbed. The effect of cleaning can be achieved when the trash or dust is inhaled by the airflow in the vacuum cleaning module, the trash or dust is filtered out and collected in the dust collection module, and only the air goes through the volume-adjustable air chamber.

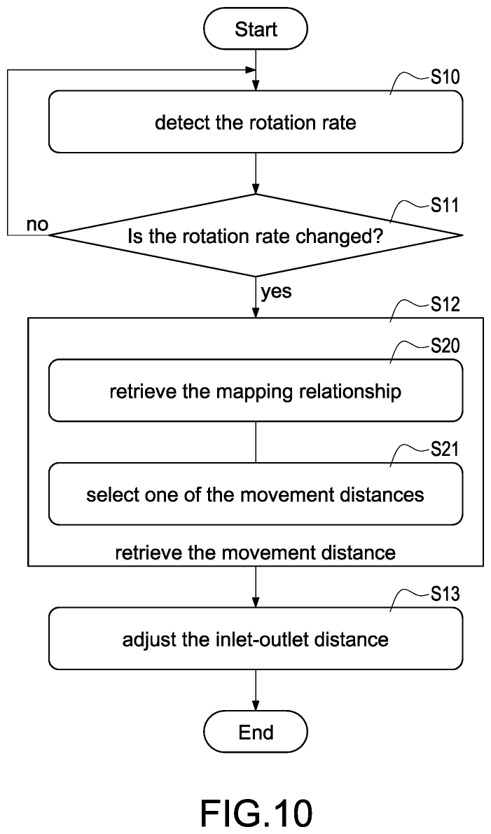

Please refer to FIG. 10. FIG. 10 is the flowchart of the method of adjusting volume of air chamber of the first embodiment of the present disclosed example. The method of adjusting volume of air chamber of each embodiment of the present disclosed example may be implemented by any of the airflow-generating devices shown in FIGS. 2A to 9.

The method of adjusting volume of air chamber of this embodiment comprises following steps.

Step S10: the control unit 200 executes the airflow control module 30 to detect the rotation rate of the airflow-generating unit 202, such as retrieving the operational parameters of the airflow-generating unit 202.

Step S11: the control unit 200 executes the airflow control module 30 to detect whether the rotation rate of the airflow-generating unit 202 is changed, such as if any operational parameter is changed.

If the rotation rate of the airflow-generating unit 202 is not changed, it is unnecessary to adjust the volume of the air chamber space 208. The control unit 200 executes the step S10 again for continuous detection.

If the rotation rate of the airflow-generating unit 202 is changed, there is a need to adjust the volume of the air chamber space 208, the control unit 200 executes the step S12: the control unit 200 executing the adjustment control module 31 to retrieves the movement distance of moving the outlet structure 201 (and/or the inlet structure 210) for this change of the rotation rate.

In one of the exemplary embodiments, a plurality of values of the rotation rates respectively correspond to a plurality of different movement distances (such as 1 centimeter, 3 centimeters or 5 centimeters). The control unit 200 is configured to retrieve the movement distance corresponding to the current changed rotation rate of the airflow-generating unit 202.

In one of the exemplary embodiments, the storage unit 204 records a mapping relationship (such as being stored in a form of lookup table) between a plurality of rotation rate configurations (such as the above-mentioned operational parameters) for the airflow-generating unit 202 and a plurality of movement distances for the adjustment unit 201. the control unit 200 may retrieve the movement distance by following steps S20-S21.

Step S20: the control unit 200 executes the adjustment control module 31 to load the mapping relationship from the storage unit 204.

Step S21: the control unit 200 executes the adjustment control module 31 to select one of the movement distances (such as selection based on the lookup table) based on the retrieved mapping relationship and rotation rate configuration currently used by the airflow-generating unit 202.

Step S13: the control unit 200 executes the adjustment control module 31 to control the adjustment unit 201 to adjust the inlet-outlet distance based on the movement distance being selected.

In one of the exemplary embodiments, the control unit 200 is configured to stretch the inlet-outlet distance for increasing the volume of the air chamber space 208 and improving the noise level of the airflow when the rotation rate of the airflow-generating unit 202 is increased. Moreover, the control unit 200 is configured to shrink the inlet-outlet distance for reducing the volume of the air chamber space 208 and aggrandizing the pressure and speed of the airflow when the rotation rate of the airflow-generating unit 202 is reduced.

Thus, the present disclosed example can increase the intensity of the airflow or reduce the noise of the airflow according to the user demand.

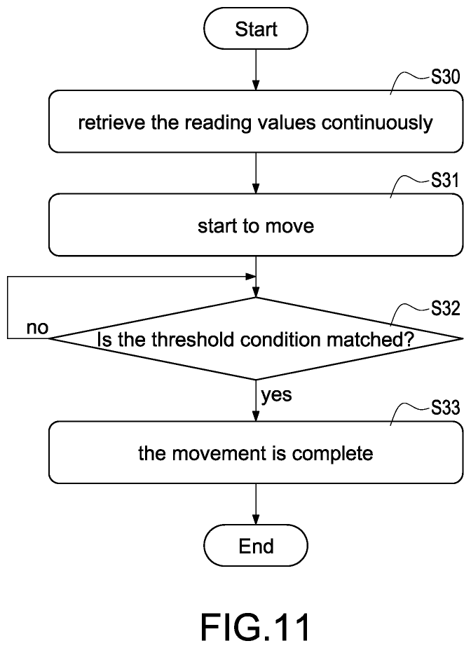

Please refer to FIG. 11. FIG. 11 is the flowchart of movement based on the condition of the second embodiment of the present disclosed example. A function of conditional movement is provided in this embodiment which is to continuously adjust the inlet-outlet distance until the default threshold condition is matched, so as to provide the user a better user experience. More specifically, the method of adjusting volume of air chamber of this embodiment further comprises following steps.

Step S30: the control unit 200 retrieves the reading values from the sensing unit 203 continuously.

In one of the exemplary embodiments, the present disclosed example further provides a function of optimizing performance, with the ability to adjust the volume of the air chamber space 208 based on the current rotation rate of the airflow-generating unit 202 for providing the best effect of air exchange rate currently. More specifically, the sensing unit 203 may be an anemometer or a barometer, and the control unit 200 may execute the module of optimizing performance 33 to retrieve the wind speed reading values or the air pressure reading values of the airflow at the outlet structure 209 continuously.

In one of the exemplary embodiments, the present disclosed example further provides a function of optimizing noise reduction with the ability to adjust the volume of the air chamber space 208 based on the current rotation rate of the airflow-generating unit 202 for minimizing the noise caused by the airflow. More specifically, the sensing unit 203 may be a decibel meter, and the control unit 200 may execute the module of optimizing noise reduction to retrieve the noise reading values of the airflow at the outlet structure 209 from the sensing unit 203 continuously.

Step S31: the control unit 200 executes the adjustment control module 31 to control the adjustment unit 201 to start to move the inlet structure 210 and/or the outlet structure 209 for stretching or shrinking the inlet-outlet distance.

Step S32: the control unit 200 determines whether the default threshold condition is matched. More specifically, as the volume of the air chamber space 208 increases or decreases, the reading value of the sensing unit 203 will change accordingly. The control unit 200 is configured to determine whether the current reading value of the sensing unit 203 is matched with the above-mentioned threshold condition (such as a default reading value).

In one of the exemplary embodiments, when the function of optimizing performance is provided, the control unit 200 may determine by the module of optimizing performance 33 whether the current wind speed reading value matches the default wind speed threshold condition (such as the current wind speed reading value being higher than a default wind speed value), or the current air pressure reading value matches the default air pressure threshold condition (such as the current air pressure reading value being higher than a default air pressure value). The above-mentioned default wind speed value or default air pressure value may be values with the ability to provide the best operational effect based on the current rotation rate.

In one of the exemplary embodiments, when the function of optimizing noise reduction is provided, the control unit 200 may determine by the module of optimizing noise reduction 34 whether the current noise reading value matches the default noise threshold condition (such as the current noise reading value being weaker than a default noise value). The above-mentioned default noise value may be a value with the ability to provide a normal noise level or lower noise level based on the current rotation rate.

Step S33: when the default threshold condition is matched, the control unit 200 executes the adjustment control module 31 to control the adjustment unit 201 to stop moving the inlet structure 210 and/or the outlet structure 209 for stopping the movement of the above-mentioned inlet-outlet distance.

Thus, the present disclosed example can provide the better user experience.

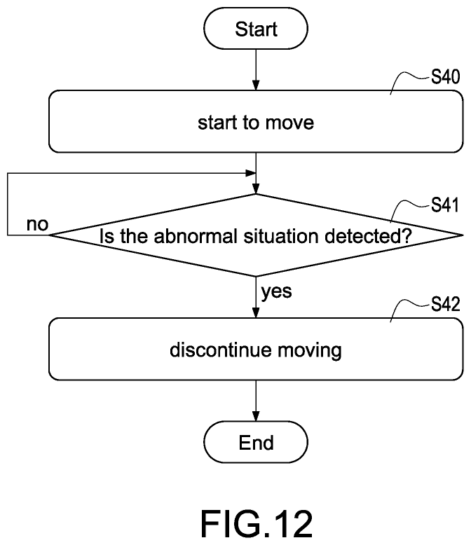

Please refer to FIG. 12. FIG. 12 is the flowchart of the anomaly detection of the third embodiment of the present disclosed example. A function of anomaly detection is provided in this embodiment with the ability to detect whether any abnormal situation happens during operation of the adjustment unit 201 for preventing the airflow-generating device from damage, such as failure of the adjustment unit 201 caused by the adjustment unit 201 being stuck by a sticky foreign matter. More specifically, the method of adjusting the volume of air chamber of this embodiment further comprises following steps.

Step S40: control unit 200 executes the anomaly-detecting module 35 to start to adjust the inlet-outlet distance.

Step S41: control unit 200 detects using the anomaly-detecting module 35 whether any abnormal situation happens when the inlet-outlet distanced is adjusted by the adjustment unit 201. For example, an abnormal increase in current of the adjustment unit 201 (indicating that there may be an obstacle stuck in the adjustment unit 201), the reading value of the sensing unit 203 does not change with the inlet-outlet distance, or an abnormal situation (such as an obstacle in the air chamber space 208) is detected by the sensing unit 203 (such as an obstacle detector), and so forth, but this specific example is not intended to limit the scope of the present disclosed example.

If there is no abnormal situation detected, the control unit 200 executes the step S41 again for continuous detection until the adjustment unit 201 completes the adjustment of the inlet-outlet distance.

If any abnormal situation is detected, the control unit 200 executes the step S42: the control unit 200 executes the anomaly-detecting module 35 controlling the adjustment unit 201 to discontinue adjusting the inlet-outlet distance.

In one of the exemplary embodiments, after discontinuing adjustment of the inlet-outlet distance, the control unit 200 may control the adjustment unit 201 using the anomaly-detecting module 35 to adjust the inlet-outlet distance in a reverse direction, such as reverting the inlet-outlet distance to the state before adjustment.

Thus, the present disclosed example can effectively detect the abnormal situation, and prevent the airflow-generating device from damage caused by continuously operating under the abnormal situation.

The above-mentioned are only preferred specific examples in the present disclosed example, and are not thence restrictive to the scope of claims of the present disclosed example. Therefore, those who apply equivalent changes incorporating contents from the present disclosed example are included in the scope of this application, as stated herein.

What is claimed is:

1. An airflow-generating device, comprising:
a volume-adjustable air chamber, comprising:
an inlet structure (210);
an outlet structure (209), wherein an air chamber space (208) being formed between the inlet structure (210) and the outlet structure (209), and a deflector structure (40,42,44) for adjusting pressure or direction of airflow being arranged on the outlet structure (210); and
an adjustment unit (201) used to adjust an inlet-outlet distance between the inlet structure (210) and the outlet structure (209) for adjusting an air chamber volume of the adjustable air chamber; and
an airflow-generating unit (202) arranged in the volume-adjustable air chamber and used to generate the airflow introduced from the inlet structure (210) into the air chamber space (208) and exhausted from the outlet structure (209).

2. The airflow-generating device according to claim 1, further comprising a control unit (200) electrically connected to the airflow-generating unit (202) and the adjustment unit (201), the control unit (200) is configured to control the adjustment unit (201) to stretch the inlet-outlet distance for increasing the air chamber volume to improve a noise level caused by the airflow when a rotation rate of the airflow-generating unit (202) speeds up, control the adjustment unit (201) to shrink the inlet-outlet distance for reducing the air chamber volume to aggrandize the pressure and speed of the airflow when a rotation rate of the airflow-generating unit (202) slows down.

3. The airflow-generating device according to claim 2, wherein the adjustment unit (201) is a screw structure device, a belt driving device or a pneumatic telescopic rod device; the airflow-generating unit (202) is a fan device.

4. The airflow-generating device according to claim 2, wherein the inlet structure (210) is fixedly arranged, and the adjustment unit (201) is connected to the outlet structure (209) and used to move the outlet structure (209) for adjusting the inlet-outlet distance.

5. The airflow-generating device according to claim 2, wherein the outlet structure (209) is fixedly arranged, and the adjustment unit (201) is connected to the inlet structure (210) and used to move the inlet structure (210) for adjusting the inlet-outlet distance.

6. The airflow-generating device according to claim 2, wherein the deflector structure (40,42,44) comprises a plurality of holes (41) or stereo deflectors (43,45).

7. The airflow-generating device according to claim 2, further comprising a storage unit (204) electrically connected to the control unit (200), where in the storage unit (204) is records a mapping relationship between a plurality of rotation rate configurations for the airflow-generating unit (202) and a plurality of movement distances for the adjustment unit (201); the control unit (200) further comprising an adjustment control module (31), the adjustment control module (31) is configured to select one of the movement distances based on the mapping relationship and the rotation rate configuration currently used by the airflow-generating device (202), and control the adjustment unit (201) to adjust the inlet-outlet distance based on the movement distance being selected.

8. The airflow-generating device according to claim 2, further comprising a sensing unit (203) electrically connected to the control unit (200), wherein the sensing unit (203) is arranged on the outlet structure (209) and used to sense a wind speed reading value or an air pressure reading value of the airflow flowing through the outlet structure (209) or sense a noise reading value of the airflow flowing through the outlet structure (209); the control unit (200) further comprises a module of optimizing performance (33) or a module of optimizing noise reduction (34); the module of optimizing performance (33) is configured to retrieve the wind speed reading values or an air pressure reading values continuously from the sensing unit (203) and control the adjustment unit (201) to stretch or shrink the inlet-outlet distance until the wind speed reading value is matched with a wind speed threshold condition or the air pressure reading value is matched with an air pressure threshold condition; the module of optimizing noise reduction (34) is configured to retrieve the noise reading values continuously from the sensing unit (203) and control the adjustment unit (201) to stretch or shrink the inlet-outlet distance until the noise reading value is matched with a noise threshold condition.

9. The airflow-generating device according to claim 2, further comprising a functional unit (206), wherein the functional unit (206) is arranged at a position which the airflow flows through before the inlet structure (210), the functional unit (206) is used to process the air before the inlet structure (210) for the airflow-generating unit (202) to introduce the air being processed into the volume-adjustable air chamber.

10. The airflow-generating device according to claim 9, wherein the functional unit (206) is an air purification device, an air heating device, an air-cooling device, an air dehumidification device, and a vacuum cleaner device.

11. A method applied to the airflow-generating device according to claim 1, comprising following steps:
a) detecting a rotation rate of the airflow-generating unit (202);
b) retrieving a movement distance corresponding to the rotation rate currently changed of the airflow-generating unit (202) when the rotation rate of the airflow-generating unit (202) is changed; and
c) controlling the adjustment unit (201) to stretch or shrink the inlet-outlet distance based on the movement distance, wherein the inlet-outlet distance is stretched when the rotation rate of the airflow-generating unit (202) speeds up for increasing the air chamber volume to improve the noise level caused by the airflow, the inlet-outlet distance is shrunk when the rotation rate of the airflow-generating unit (202) slows down for reducing the air chamber volume to aggrandize the pressure and speed of the airflow.

12. The method according to claim 11, wherein the step b) comprises following steps:
b1) retrieving a mapping relationship between a plurality of rotation rate configurations for the airflow-generating unit (202) and a plurality of movement distances for the adjustment unit (201); and
b2) selecting one of the movement distances based on the mapping relationship and the rotation rate configuration currently used by the airflow-generating device (202).

13. The method according to claim 11, further comprising following steps:
d1) retrieving wind speed reading values or an air pressure reading values at the outlet structure (209) continuously from a sensing unit (203) arranged on the outlet structure (209); and
d2) controlling the adjustment unit (201) to stretch or shrink the inlet-outlet distance until the wind speed reading value is matched with a wind speed threshold condition or the air pressure reading value is matched with an air pressure threshold condition.

14. The method according to claim 11, further comprising following steps:
e1) retrieving noise reading values at the outlet structure (209) continuously from a sensing unit (203) arranged on the outlet structure (209); and
e2) controlling the adjustment unit (201) to stretch or shrink the inlet-outlet distance until the noise reading value is matched with a noise threshold condition.

15. The method according to claim 11, further comprising a step f) controlling the adjustment unit (201) to discontinue adjusting the inlet-outlet distance when any abnormal situation is detected during the inlet-outlet distance adjustment by the adjustment unit (201).
